(19) United States
(12) Patent Application Publication
(10) Pub. No.: US 2006/0165041 A1
(43) Pub. Date: Jul. 27, 2006

(54) Apparatus and method for acquiring pilot synchronization in a code division multiple access system

(75) Inventors: Jae-Ho Song, Suwon-si (KR); Hye-Jeong Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/336,884

(22) Filed: Jan. 23, 2006

(30) Foreign Application Priority Data
Jan. 22, 2005 (KR) 2005-6115

(51) Int. Cl. H04B 7/216; H04B 3/10

(52) U.S. Cl. 370/335; 370/491; 370/342

(57) ABSTRACT

An apparatus and method for acquiring a pilot channel in a code division multiple access (CDMA) system. A signal strength detector detects signal strength values for all pseudo-random noise (PN) hypotheses from a despread received signal. A PN hypothesis selector selects PN hypotheses whose detected signal strength values are greater than or equal to a particular threshold. A searcher controller sorts the selected PN hypotheses in order of a high signal strength value, and generates PN sequences in the order of the high signal strength value. A PN sequence generator generates PN sequences for the PN hypotheses. A PN mask shifts a signal output of the PN sequence generator to a position of a PN hypothesis, according to signal strength.

### PRIORITY

This application claims the benefit under 35 U.S.C. § 119(a) of Korean Patent Application entitled “Apparatus and Method for Acquiring Pilot Synchronization in a Code Division Multiple Access System” filed in the Korean Intellectual Property Office on Jan. 22, 2005 and assigned Serial No. 2005-6115, the entire disclosure of which is hereby incorporated by reference.

### BACKGROUND OF THE INVENTION

1. Field of the Invention

The present invention relates generally to an apparatus and method for acquiring pilot synchronization in a wireless communication system. More particularly, the present invention relates to an apparatus and method for acquiring pilot synchronization in a Code Division Multiple Access (CDMA) wireless communication system.

2. Description of the Related Art

Wireless communication systems have been developed to allow users to enjoy communication without restrictions. A CDMA system is a typical wireless communication system, in which a mobile station operates in any one of initialization, idle and traffic processes (or states). In the initialization process, the mobile station performs a pilot channel acquisition process after a system determination process.

The pilot channel acquisition process is preferably performed by the mobile station for communication with the system. The mobile station is synchronized with a base station by acquiring a pilot channel. After a sync acquisition, the mobile station acquires a variety of information from the base station and then communicates with the base station. A conventional pilot channel acquisition process has a long processing time because the process verifies several steps of pseudo-random noise (PN) hypothesis one by one. Herein, the term “one PN hypothesis” refers to one start point of a PN sequence. However, a PN sequence shifted once from a particular PN sequence can be another PN hypothesis. As a result, the mobile station searches for numerous hypotheses one by one, causing an increase in time required for verifying PN sequences.

Accordingly, there is a need for a method for acquiring synchronization within a short time, using an efficient pilot channel acquisition operation.

### SUMMARY OF THE INVENTION

An aspect of embodiments of the present invention is to address at least the above problems and/or disadvantages and to provide at least the advantages described below. Accordingly, an aspect of embodiments of the present invention is to provide an apparatus and method for improving pilot channel acquisition performance in a CDMA system.

It is another object of the present invention to provide an apparatus and method for reducing a pilot channel acquisition time in a CDMA system.

It is further another object of the present invention to provide an apparatus and method for selecting a PN hypothesis with the highest signal strength from all PN hypotheses in a pilot channel acquisition process to increase synchronous channel demodulation performance and reduce the probability of a need to perform handoff immediately after entering an idle process in a CDMA system.

According to one aspect of an exemplary embodiment of the present invention, there is provided an apparatus for acquiring a pilot channel in a code division multiple access (CDMA) system. The apparatus comprises a signal strength detector for detecting signal strength values for all pseudo-random noise (PN) hypotheses from a despread received signal. A PN hypothesis selector selects PN hypotheses whose detected signal strength values are greater than or equal to a particular threshold. A searcher controller sorts the selected PN hypotheses in order of a high signal strength value, and generates PN sequences in the order of the high signal strength value. A PN sequence generator generates PN sequences for the PN hypotheses. A PN mask shifts a signal output of the PN sequence generator to a position of a PN hypothesis, according to signal strength.

According to another aspect of an exemplary embodiment of the present invention, there is provided a method for acquiring a pilot channel by a mobile station in a code division multiple access (CDMA) system. The method comprising searching for all pseudo-random noise (PN) hypotheses. PN hypotheses whose signal strength values are greater than or equal to a particular threshold are selected among the searched PN hypotheses. The selected PN hypotheses are sorted in order of a high signal strength value, and PN sequences are generated in the order of the high signal strength value. A PN sequence is shifted to a position of the selected PN hypothesis using a PN mask. A pilot channel is acquired using the position-shifted PN sequence.

### BRIEF DESCRIPTION OF THE DRAWINGS

The above and other objects, features and advantages of certain exemplary embodiments of the present invention will be more apparent from the following detailed description when taken in conjunction with the accompanying drawings, in which:

FIG. 1 is a block diagram illustrating a receiving unit of a mobile station for acquiring pilot synchronization according to an exemplary embodiment of the present invention;

FIG. 2 is a flowchart illustrating a procedure for acquiring pilot synchronization by a mobile station according to an exemplary embodiment of the present invention;

FIG. 3 is a diagram for a description of position shifting for acquiring pilot synchronization; and

FIG. 4 is a diagram for a description of position shifting for acquiring pilot synchronization using a PN mask according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and method for reducing a synchronization acquisition time in a pilot channel acquisition process and selecting a PN hypothesis with the highest signal strength from all PN hypotheses to increase channel demodulation performance in a CDMA system.

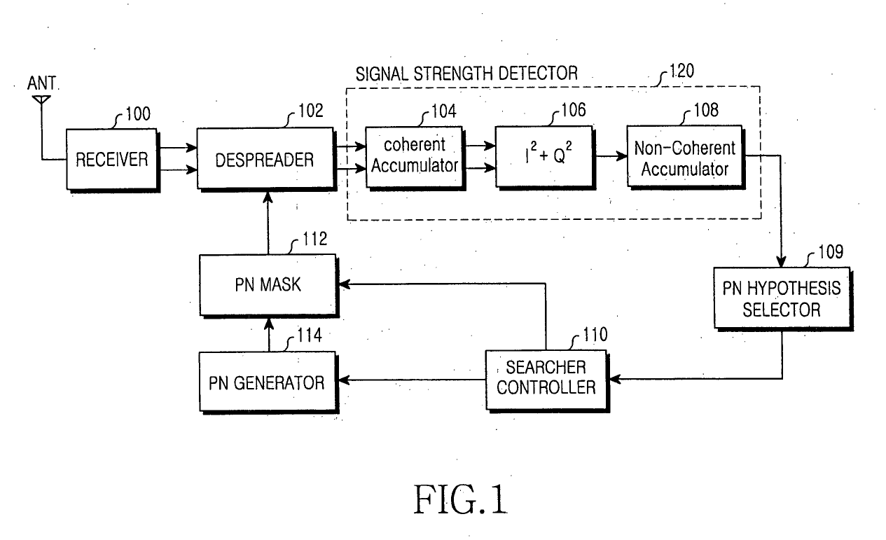

With reference to FIG. 1, a description will now be made of an internal structure for acquiring a pilot channel in a mobile station according to an exemplary embodiment of the present invention. FIG. 1 is a block diagram illustrating a receiving unit of a mobile station for acquiring pilot synchronization according to an exemplary embodiment of the present invention.

A spread signal received through an antenna ANT and a receiver 100 is despread by a despreader 102 in order to restore the spread signal into its original signal. The despreader 102 uses a PN sequence generated in a PN generator 114 for dispreading the received signal, and estimates that energy, that is, strength of the received signal is high, if the generated PN sequence is in sync with the received signal. In FIG. 1, a signal generated by the PN generator 114 is provided to the despreader 102 via a PN mask 112. The PN mask is used for position shifting of a PN sequence. The PN signal generated in the PN generator 114 is provided intact to the despreader 102, if there is no need for position shifting of the PN sequence. As described above, a position of a PN sequence generated in the PN generator 114 is called a hypothesis, and such PN hypotheses can shift from 0th through 32768th chip through a searcher controller 110. If the PN signal or PN sequence can shift from 0th through 32768th chip on a chip-by-chip basis, there are a total of 32769 possible hypotheses. However, in order to use a large-size window for shifting in units of tens to hundreds of chips, a predetermined number of hypotheses may be used.

Energy of the despread signal output from the despreader 102 is calculated by a signal strength detector 120 comprised of a coherent accumulator 104, a signal strength calculator (I²+Q²) 106 and a non-coherent accumulator 108. The calculated energy is output to a PN hypothesis selector 109. The PN hypothesis selector 109 then selects PN hypotheses with a high energy value from the PN hypotheses, and outputs energy and position information of the selected PN hypotheses to the searcher controller 110.

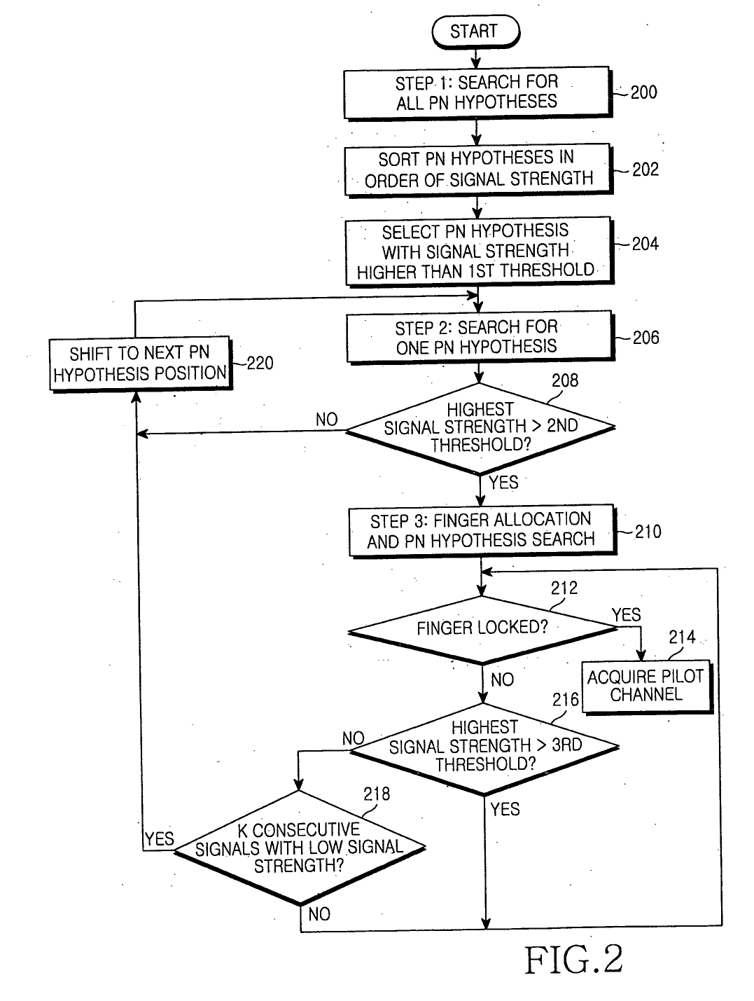

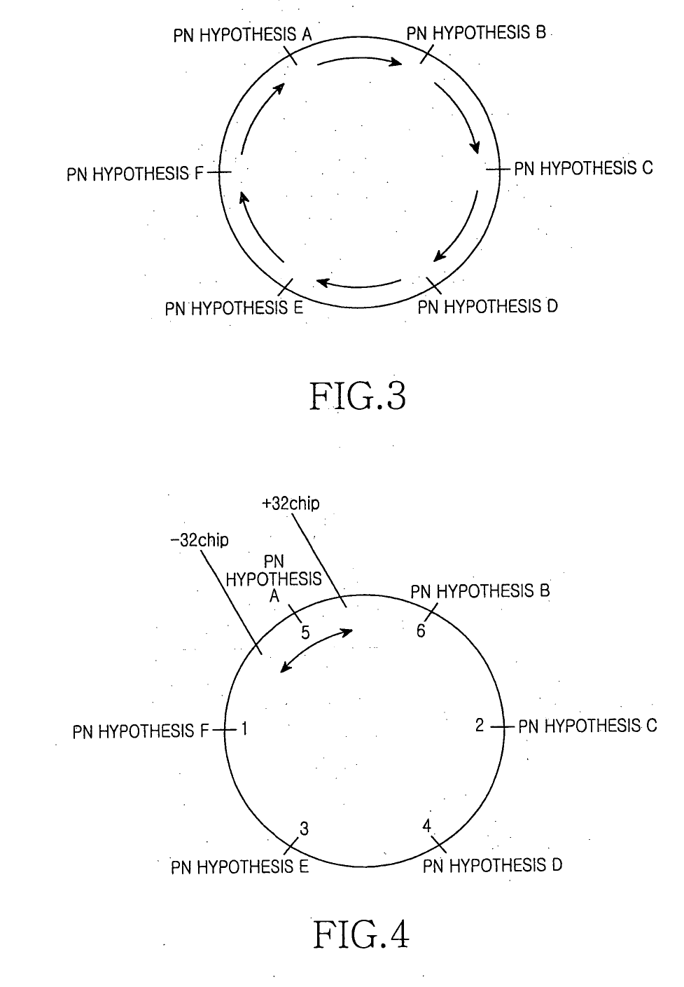

Before a detailed description of an exemplary embodiment of the present invention with reference to FIG. 2 is given, a brief description of each function in the receiving unit of the mobile station, according to an exemplary implementation, will be made below. In Step 1 of FIG. 2, all PN hypotheses are searched. In a PN hypothesis selector, “all PN hypotheses” refers to a predetermined number of hypotheses having a large-size window. Referring to FIGS. 3 and 4, all PN hypotheses are roughly divided into six large hypotheses of A, B, C, D, E and F, for the search. For example, the total number of hypotheses can be 6. Accordingly, a searcher controller 110 enables a PN generator 114 to generate a corresponding PN sequence according to a position of a predetermined hypothesis and a window size. The generated PN signal is input to a PN mask 112. The PN mask 112 performs a PN masking operation, if there is a need for shifting to a corresponding PN position. However, if there is no need for the shifting, the PN mask 112 provides the generated PN sequence to a despreader 102 without masking, and the despreader 102 despreads a received signal with the PN sequence. In handling all the hypotheses, the PN hypothesis selector 109 selects PN hypotheses with a large window size, having signal strength being higher than or equal to a first threshold. In step 202 of FIG. 2, the selected PN hypotheses are sorted in order of their signal strength. In step 204, a PN hypothesis with the highest signal strength is selected to increase a success probability of acquiring a pilot channel. The increase in the success probability of acquiring a pilot channel reduces a time required for achieving stabilization after entering an idle process from an initialization process. In step 206, detailed hypothesis verification is performed on each of the selected PN hypotheses. The searcher controller 110 controls the PN generator 114 to generate a PN sequence having a window, which is smaller in size than the window used in Step 1, for each of the selected PN hypotheses. Thereafter, a signal strength detector determines whether the highest signal strength is higher than a second threshold. If the highest signal strength is higher than the second threshold, a filter allocation process is performed.

When several PN hypotheses should be searched, the hypothesis to be searched next is random in position. Therefore, in order to search for the next PN hypothesis, a position shifting method, according to an exemplary embodiment of the present invention, is used based on a PN mask 112 for position shifting. That is, when PN hypotheses are sequentially searched, according to the conventional method, as shown in FIG. 3, it is possible to directly shift to the next hypothesis for the hypothesis search. However, in searching for the PN hypotheses in order of the highest signal strength according to an exemplary embodiment of the present invention, a time required for shifting in order to search for the next PN hypothesis increases. In order to compensate for the time increase, an exemplary implementation of the present invention uses a PN mask 112. The use of the PN mask can noticeably reduce the time required for shifting a position of a hypothesis because an actual shift value falls within ±32 chips even though a position of the PN hypothesis is randomly changed. For example, as shown in FIG. 1, if there is no need for position shifting by the searcher controller 110, the PN mask 112 outputs a PN signal that was generated in the PN generator 114, having a predetermined start point, to the despreader 102 without masking. However, if there is a need to shift a PN start point for the signal generated by the PN generator 114 in order of the signal strength, the searcher controller 110 activates the PN mask 112. The PN mask 112 masks the output of the PN generator 114 according to the signal generated by the searcher controller 110. Accordingly, a start point of the PN signal generated by the PN generator 114 can shift from a PN hypothesis A to a PN hypothesis D, or from a PN hypothesis C to a PN hypothesis F, as shown in FIG. 4. The masking serves to generate the same PN code, by shifting the start point of the PN code.

With reference to FIG. 4, a description will now be made of a method for shifting a PN position using the PN mask 112. FIG. 4 illustrates a diagram of a method for shifting a position of a PN hypothesis to be searched in order to acquire pilot synchronization using a PN mask 112, according to an exemplary embodiment of the present invention.

Referring to FIG. 3, which illustrates the conventional method of shifting a position of a PN hypothesis for pilot synchronization acquisition, a circle represents all of 32768 PN hypotheses. PN hypotheses A through F represent the PN hypotheses that a mobile station has obtained through the PN hypothesis search. In order to search for PN hypotheses A through F, the conventional method searches all PN positions along the circle.

On the contrary, referring to FIG. 4, which illustrates pilot synchronization acquisition according to an exemplary embodiment of the present invention, the searcher controller 110 in FIG. 1 generates a shifted PN sequence, without actually shifting the PN sequence generated in the PN generator 114 using the PN mask 112. The PN mask 112 is commonly used to search for base stations spaced apart in units of 64 chips in an idle state or a traffic state. Because the allowed shift unit is 64 chips, position shifting may be achieved within a range of 64 chips in order to apply the 64-chip shift unit in a pilot channel acquisition. That is, the use of the PN mask 112 allows a PN hypothesis to shift only within ±32 chips from the current position.

Therefore, exemplary implementations of the present invention can shift within ±32 chips in searching for the PN hypotheses A through F. For example, if the PN hypothesis F is a hypothesis to be searched, the conventional method checks all PN hypotheses, shifting from the PN hypothesis A through the PN hypothesis F. On the other hand, a method according to an exemplary embodiment of the present invention can determine in Step 1 that the hypothesis F is a hypothesis with the highest energy, and can check a hypothesis by shifting a maximum of ±32 chips from the current position, rather than shifting to a position of the hypothesis F. After detecting the pilot acquisition, it is necessary to actually shift a searcher and a finger for shifting a PN sequence of the PN generator 114 to a position of a hypothesis.

Upon receiving signal strength and position information for the selected PN hypothesis, the searcher controller 110 acquires synchronization with the base station using the energy and position information of the PN hypotheses.

With reference to FIG. 2, a description will now be made of an operation for acquiring a pilot channel in a receiving unit of a mobile station shown in FIG. 1. FIG. 2 illustrates a flowchart of a procedure for acquiring pilot synchronization by a mobile station according to an exemplary embodiment of the present invention.

In step 200, all PN hypotheses are searched at high speed by reducing a coherent length and a number of non-coherents to their lower limits. In particular, the method according to an exemplary embodiment the present invention, uses signal strength information of the PN hypotheses selected in step 200. After searching for all PN hypotheses in step 200, the novel method sorts the searched PN hypotheses among all the PN hypotheses in order of a PN hypothesis with the highest signal strength in step 202. A success probability of acquiring a pilot channel almost approaches 100% at the PN hypothesis with the highest signal strength. In a low-power area or an overlapping area, the acquisition of a pilot channel succeeds in most cases at a PN hypothesis with the highest signal strength, a PN hypothesis with the second highest signal strength, or a PN hypothesis with the third highest signal strength. Accordingly, the use of the signal strength of the PN hypothesis reduces the need to search for many PN hypotheses, making it possible to acquire a pilot channel within a short time.

If it is necessary to search for several PN hypotheses when pilot channel acquisition at a first or second PN hypothesis has failed, the PN hypothesis to be searched next is in a random position. Therefore, the method, according to an exemplary embodiment of the present invention, requires a much longer time in shifting for searching for the next hypothesis. In order to compensate for the longer time, PN mask-based position shifting is used. The use of the PN mask contributes to a remarkable reduction in the time required for shifting a position of a hypothesis because an actual shift value falls within ±32 chips even though a position of the PN hypothesis is randomly changed.

In step 204 of FIG. 2, PN hypotheses with signal strength being higher than or equal to a first threshold are selected from the PN hypotheses sorted in order of the signal strength in steps 200 and 202. Herein, the “first threshold” refers to a reference value previously set to an approximate value of guaranteeing a pilot channel acquisition possibility. In step 204, the PN hypotheses with signal strength being higher than or equal to the first threshold can be selected as described above, or a predetermined number of PN hypotheses can be selected without using the first threshold. By reducing the number of PN hypotheses used for success in the pilot channel acquisition, as described in step 204, a determination of the pilot channel acquisition failure can be made quickly.

Thereafter, in step 206, a PN hypothesis with the highest signal strength is searched from the PN hypotheses selected in step 204, with a window reduced in size. In step 206, which performs a fine search by increasing parameters, such as, the coherent length and the number of non-coherents, a correct current position around the position searched in step 200 is searched again. Thereafter, a determination is made in step 208 as to whether the highest signal strength is higher than or equal to a second threshold. If the highest signal strength is lower than the second threshold, the procedure proceeds to step 220 where a shift is made to the next PN hypothesis position and then the PN hypothesis is searched. The procedure determines in step 208 whether a corresponding PN hypothesis is appropriate for pilot channel acquisition, using the second threshold being higher than the first threshold.

If it is determined in step 208 that the highest signal strength searched at the corresponding PN hypothesis is higher than or equal to the second threshold, the procedure allocates a finger and searches for a PN hypothesis in step 210. Thereafter, if the finger is locked in step 212, the procedure proceeds to step 214 where a pilot channel is acquired. However, if the finger is not locked, the procedure determines in step 216 whether the highest signal strength is higher than or equal to a third threshold. If the highest signal strength is higher than or equal to the third threshold, the procedure continues to determine in step 212, during frequency tracking, whether the finger is locked. However, if a determination is made in step 216 that the highest signal strength is lower than the third threshold, the procedure determines in step 218 whether the highest signal strength is lower than the third threshold number, K or more, of times consecutively. If the highest signal strength is lower than the third threshold K or more number of times consecutively, the procedure proceeds to step 220 where a shift is made to the next PN hypothesis position and then returns to searching for the PN hypothesis (step 206). If the searched signal strength fails to exceed the threshold several times, if the finger cannot be locked, or frequency stabilization is not achieved during frequency tracking, the procedure proceeds to step 220 where the next hypothesis is selected, by shifting to the next PN hypothesis position and then the next PN hypothesis is searched. If the PN hypothesis does not satisfying the pilot channel acquisition conditions, even after searching all the PN hypotheses selected in step 206, the mobile station fails in the pilot channel acquisition. If the mobile station fails in the pilot channel acquisition, the pilot channel acquisition procedure of FIG. 3 is repeated, while several conditions in the pilot channel acquisition are changed, such as, frequency channel, the number of hypotheses, search condition and energy threshold.

As can be understood from the foregoing description, exemplary embodiments of the present invention allows a mobile station to select a PN hypothesis with the highest signal strength from all PN hypotheses contained, thereby contributing to an increase in pilot channel acquisition performance and synchronization channel demodulation performance and a reduction in average pilot acquisition time. In addition, exemplary embodiments of the present invention can noticeably reduce the pilot acquisition time when the mobile station performs handoff immediately after entering the idle state, thereby reducing the time required for being stabilized after transitioning from the initialization process to the idle process.

While the invention has been shown and described with reference to certain exemplary embodiment thereof, it will be understood by those skilled in the art that various changes in form and details may be made therein without departing from the spirit and scope of the invention as defined by the appended claims.

What is claimed is:

1. An apparatus for acquiring a pilot channel in a code division multiple access (CDMA) system, the apparatus comprising:
a signal strength detector for detecting signal strength values for pseudo-random noise (PN) hypotheses from a despread received signal;
a PN hypothesis selector for selecting PN hypotheses comprising detected signal strength values greater than or equal to a threshold;
a searcher controller for sorting the selected PN hypotheses in order of a high signal strength value, and generating PN sequences in the order of the high signal strength value;
a PN sequence generator for generating PN sequences for the PN hypotheses; and
a PN mask for shifting a signal output of the PN sequence generator to a position of a PN hypothesis, according to signal strength of the PN hypothesis.

2. The apparatus of claim 1, wherein the searcher controller allocates a finger to the selected PN hypothesis, and acquires a pilot channel with the PN hypothesis, if the allocated finger is locked.

3. The apparatus of claim 2, wherein if the allocated finger is not locked, the searcher controller checks pilot channel acquisition for a PN hypothesis with the next high signal strength.

4. The apparatus as of claim 1, wherein the signal strength detector detects signal strength values for all of the PN hypotheses from a despread received signal.

5. A method for acquiring a pilot channel by a mobile station in a code division multiple access (CDMA) system, the method comprising the steps of:
searching for pseudo-random noise (PN) hypotheses;
selecting PN hypotheses, among the searched PN hypotheses, whose signal strength values are greater than or equal to a threshold;
sorting the selected PN hypotheses in order of a high signal strength value, and generating PN sequences in the order of the high signal strength value;
shifting a PN sequence to a position of the selected PN hypothesis using a PN mask; and
acquiring a pilot channel using the position-shifted PN sequence.

6. The method of claim 5, wherein the pilot channel acquisition step comprises allocating a finger using the selected PN hypothesis, and acquiring a pilot channel by determining whether the allocated finger is locked.

7. The method of claim 6, further comprising the step of checking whether pilot channel acquisition is possible for a PN hypothesis with the next high signal strength, if the allocated finger is not locked.

8. The method of claim 5, wherein the searching comprises searching for all the PN hypotheses.
